(19) United States
(12) Patent Application Publication
(10) Pub. No.: US 2013/0343219 A1
(43) Pub. Date: Dec. 26, 2013

(54) Method for Determining White Space Interference Margin

(71) Applicants: Jonas Kronander, Uppsala (SE); Yngve Selén, Uppsala (SE)

(72) Inventors: Jonas Kronander, Uppsala (SE); Yngve Selén, Uppsala (SE)

(73) Assignee: TELEFONAKTIEBOLAGET L M ERICSSON (PUBL), Stockholm (SE)

(21) Appl. No.: 14/003,254

(22) PCT Filed: Mar. 11, 2011
(86) PCT No.: PCT/SE2011/050269

§ 371 Date: Sep. 5, 2013

(51) Int. Cl. H04W 52/28

(52) U.S. Cl. CPC H04W 52/28
USPC 370/252

(57) ABSTRACT

The disclosure relates to a network node of a wireless network, and to a related method for determining a margin of an interference level. The network node controls at least one white space device, and the interference level is associated with a critical position and a channel available for secondary usage by the at least one white space device. The method comprises the following steps: (a) initializing (410) the margin; (b) determining (420) a transmit power level for the at least one white space device when transmitting on the channel available for secondary usage, based on the interference level with the margin added; (c) calculating (430) a probability that an aggregated interference from the at least one white space device at the critical position exceeds the interference level, based on the determined transmit power level and a channel model uncertainty; and (d) modifying (440) the margin of the interference level if the calculated probability falls outside of a probability interval. The method also comprises iterating the steps (b), (c), and (d) until the calculated probability falls within the probability interval.

### TECHNICAL FIELD

The disclosure relates to the field of power allocation in white space operation. More particularly, the disclosure relates to a network node controlling at least one white space device and a method for determining a margin of an interference level associated with a critical position and a channel available for secondary usage by the at least one white space device.

### BACKGROUND

Spectrum scarcity is a problem that has been observed in regulative frequency allocation charts for some time. All potentially interesting spectrum bands for mobile communication are already allocated to services. However, additional spectrum for mobile broadband is needed to cope with the exponential take-off of mobile broadband. At the same time traditional spectrum regulatory methods are perceived too slow to adapt to the sometimes rapidly changing economic and technical requirements, implying that large parts of the electromagnetic spectrum is licensed but not effectively used.

In particular, the TV broadcast spectrum is not efficiently used due to the way the TV broadcast networks have been deployed. They are based on the concept of high transmit towers with high transmit power serving large areas with digital or analog TV. This type of deployment makes the frequency reuse distance large—in the order of 100 km—implying a spatially sparse use of the frequency band. The geographical areas where a TV frequency channel is not in use have been termed TV white space for that channel.

Motivated by the underutilization of e.g. the TV broadcast bands, the research community has during the last decade performed research into so called secondary spectrum access. The goal of secondary spectrum access is to use licensed but unused parts of the spectrum, e.g. the TV broadcast bands, for communication in such a way that a primary user, i.e., the user of the service provided by the license holder, is not negatively affected by the secondary transmissions.

The central idea behind secondary spectrum access is thus to use already licensed spectrum for secondary purposes, i.e., for communication between a secondary transmitter and a secondary receiver. As an example, TV broadcast spectrum may be used for secondary purpose in the TV white spaces. The secondary user may also be referred to as a white space device (WSD), which is thus a device that opportunistically uses spectrum licensed for a primary service on a secondary basis at times or locations where a primary user is not using the spectrum. As already mentioned above, the WSD is not allowed to cause harmful interference to the primary service. Furthermore, the WSD is not protected from interference from any primary service or user.

Recently, the United States (US) regulatory body Federal Communications Commission (FCC) has opened up the opportunity for secondary usage of the TV broadcast band in the US under a set of conditions. Furthermore, the regulator authority Ofcom is well on the progress of finalizing a rule set that allows secondary usage of the TV broadcast bands in the United Kingdom (UK). In Europe, the regulatory standardization group European Conference of Postal and Telecommunications Administrations (CEPT) SE43 has lately finalized a report outlining the requirements for operating as a secondary user in the TV white spaces. Thus, the process of opening up TV white spaces for secondary usage around the globe is well under way.

One commonality to the rules in place in the US and the proposed rules in Europe and UK is that one allowed way of discovering spectrum opportunities for secondary usage to get access to the TV white spaces, i.e., perform secondary transmissions in the TV bands, is to access a centrally managed database referred to as a geo-location database. Upon a query from a secondary user or a WSD, the geo-location database provides the WSD with a list of TV channels available for secondary usage, also called TV white space channels, at the location of the WSD. The WSD may provide information regarding its location and possibly also additional information in the database query. Furthermore, in the CEPT SE43 proposal, the WSD obtains maximum allowed transmit power levels associated with the channels available for secondary usage in the response from the database. These transmit power levels are based on an estimation of how much interference that would be generated in a worst case, including a margin to take into account the aggregated interference from multiple WSD.

A more elaborate approach to the geo-location database functionality has been proposed by CEPT SE43 in the report “TECHNICAL AND OPERATIONAL REQUIREMENTS FOR THE POSSIBLE OPERATION OF COGNITIVE RADIO SYSTEMS IN THE ‘WHITE SPACES’ OF THE FREQUENCY BAND 470-790 MHZ”, Annex 3 to Doc. SE43(10)103. The approach is referred to as the master-slave approach, in which a master network node makes database requests for its associated slave WSD. In one example, the master network node is a base station (BS) and the slave WSD are the User Equipments (UE) served by the BS. The master-slave approach enables easier operation of a standard cellular system in the TV white spaces since the UEs need not send requests to the database. The master network node is responsible for allocating TV channels and associated output powers to the slave WSDs.

An example of a master-slave scenario is illustrated in FIG. 1a. The secondary system 20 may e.g. be an evolved Universal Terrestrial Radio Access Network (e-UTRAN) which is the radio access network of a Long Term Evolution (LTE) system. In an e-UTRAN, a UE is wirelessly connected to a radio base station (RBS) commonly referred to as an evolved NodeB (eNB). In FIG. 1a, a white space enabled eNB 100 is the master node. This master node provides a certain service coverage area 110 in the LTE system. The UEs 150a-b are slave WSDs positioned within the service coverage area 110 of the master eNB 100 and are thus served or controlled by the eNB. The master eNB 100 is connected to the geo-location database 160, typically via the Internet. The primary system 10 is in the example scenario a TV broadcast system providing a TV broadcast service to the primary TV receivers 170 in a certain service area 130.

The master node thus queries the geo-location database for channels available for secondary usage. In the response from the geo-location database, the master node also receives critical positions, and corresponding interference threshold levels associated with the channels available for secondary usage. FIG. 1b illustrates an example scenario with a primary protection zone 130 and a master node service area or secondary service area 110, and the set of points that are defined as the critical positions 140. A critical position may be defined as the point on the primary service coverage area which is closest to some point of the secondary service area, this critical position thus being affected the most by interference from the secondary usage. The interference threshold levels for each critical position received from the geo-location database, corresponds to the maximally allowed aggregated interference level, generated from the master node and the associated controlled WSDs at the respective critical position.

Based on this information the master network node may derive a set of constraints for each allowed channel that are to be respected by the uplink (UL) power allocation procedure in the secondary system. These constraints dictate that the total aggregated interference generated at a critical position must be kept below the interference threshold level received from the geo-location database, i.e. the maximally allowed aggregated interference level.

The master node service area may contain a large number of served WSDs. When the master node queries the database for its whole service area, the geo-location database would have to include a margin for aggregated interference from multiple WSDs. As the geo-location database does not have any information of the specific WSD locations or of the actual usage of white space channels by the WSDs, the included margin would have to be based on a worst case assumption. Therefore, allowed transmit powers for WSDs, derived by a master network node based on the interference threshold level obtained from the geo-location database, are suboptimal, as they do not take into account the distribution of the aggregated interference dynamically. The secondary system will therefore be overly constrained in its power allocation. With a suboptimal allocation of transmit power to a WSD in the secondary system, the WSD may not be able to fully exploit the possibilities it actually would have, given the interference rejection capabilities of the primary system. Furthermore, the master node would not be able to adapt the transmit powers of WSDs when e.g. some WSDs are switched off or moved to locations more distant from the primary system that needs to be protected.

### SUMMARY

An object is therefore to address some of the problems and disadvantages outlined above, and to allow for an optimal transmit power allocation by letting the master network node determine the margin of the interference allowed at the critical position based on its knowledge about secondary channel usage by white space devices controlled by the master network node, instead of relying on an interference margin determined by the geo-location database. This object and others are achieved by the method and network node according to the independent claims, and by the embodiments according to the dependent claims.

In accordance with a first aspect of embodiments, a method in a network node of a wireless network for determining a margin of an interference level is provided. The network node controls at least one white space device, and the interference level is associated with a critical position and a channel available for secondary usage by the at least one white space device. The method comprises the following steps: a) initializing the margin; b) determining a transmit power level for the at least one white space device when transmitting on the channel available for secondary usage, based on the interference level with the margin added; c) calculating a probability that an aggregated interference from the at least one white space device at the critical position exceeds the interference level, based on the determined transmit power level and a channel model uncertainty; and d) modifying the margin of the interference level if the calculated probability falls outside of a probability interval. The method also comprises iterating the steps b), c), and d) until the calculated probability falls within the probability interval.

In accordance with a second aspect of embodiments, a network node for a wireless network is provided. The network node is configured to determine a margin of an interference level and to control at least one white space device, wherein the interference level is associated with a critical position and a channel available for secondary usage by the at least one white space device. The network node comprises an initializing circuit configured to initialize the margin, and a determining circuit configured to determine a transmit power level for the at least one white space device when transmitting on the channel available for secondary usage, based on the interference level with the margin added. It also comprises a calculating circuit configured to calculate a probability that an aggregated interference from the at least one white space device at the critical position exceeds the interference level, based on the determined transmit power level and a channel model uncertainty, and a modifying circuit configured to modify the margin of the interference level, if the calculated probability falls outside of a probability interval. The network node also comprises an iterating circuit configured to control the determining circuit, calculating circuit, and modifying circuit to iterate the transmit power level determination, the probability calculation and the margin modification, until the calculated probability falls within the probability interval.

An advantage with allowing the network node to tune the margin of the interference levels allowed at a critical position based on the iterative method is that the margin must not be set according to worst case assumptions. This will in turn result in larger allowed secondary output powers which imply a better secondary service performance.

Other objects, advantages and novel features of embodiments will be explained in the following detailed description when considered in conjunction with the accompanying drawings and claims.

### BRIEF DESCRIPTION OF THE DRAWINGS

FIG. 1a is a block diagram illustrating a primary and a secondary system wherein embodiments may be implemented.

FIG. 1b illustrates critical positions associated with a primary protection zone and a master node service area for a particular channel.

FIG. 2 illustrates schematically a white space device uplink transmission scenario.

FIGS. 3a-3e illustrate different aspects of an example scenario according to embodiments.

FIGS. 4a-4b are flowcharts of the method performed by the network node according to embodiments.

FIGS. 5a-5b are block diagrams illustrating the network node according to embodiments.

### DETAILED DESCRIPTION

In the following, different aspects will be described in more detail with references to certain embodiments and to accompanying drawings. For purposes of explanation and not limitation, specific details are set forth, such as particular scenarios and techniques, in order to provide a thorough understanding of the different embodiments. However, other embodiments that depart from these specific details may also exist.

Moreover, those skilled in the art will appreciate that while the embodiments are primarily described in form of a method and a device, they may also be embodied in a computer program product as well as in a system comprising a computer processor and a memory coupled to the processor, wherein the memory is encoded with one or more programs that may perform the method steps disclosed herein.

Embodiments are described herein by way of reference to particular example scenarios. Particular aspects are described in a non-limiting general context in relation to a primary TV broadcast system and a secondary LTE system. It should though be noted that the embodiments may also be applied to other types of primary and secondary systems such as evolved LTE, Universal Mobile Telecommunications System (UMTS), cdma2000, WiFi, distance measuring equipment for aeronautical navigation purposes and radar systems.

In embodiments of the invention, the problem of using an unnecessarily large margin for the interference threshold level, i.e. the maximally allowed aggregated interference level, in a critical position when determining transmit power levels for WSDs, is addressed by a solution where the interference level margin is determined by the network node controlling the WSDs with an iterative method, instead of using a margin specified by the geo-location database based on a worst case assumption. In this way an optimal power allocation for multiple simultaneous transmissions in a secondary wireless system operating in white spaces may be determined, where the power allocation respects the constraints imposed by primary user protection.

This disclosure introduces an iterative method to dynamically determine the margin to the interference level specified by the geo-location database, so that the probability of causing an aggregated interference towards any of the critical locations is kept below a maximally allowed interference level. The aggregated interference probability distribution can in most cases not be obtained analytically, and therefore an iterative approach is used.

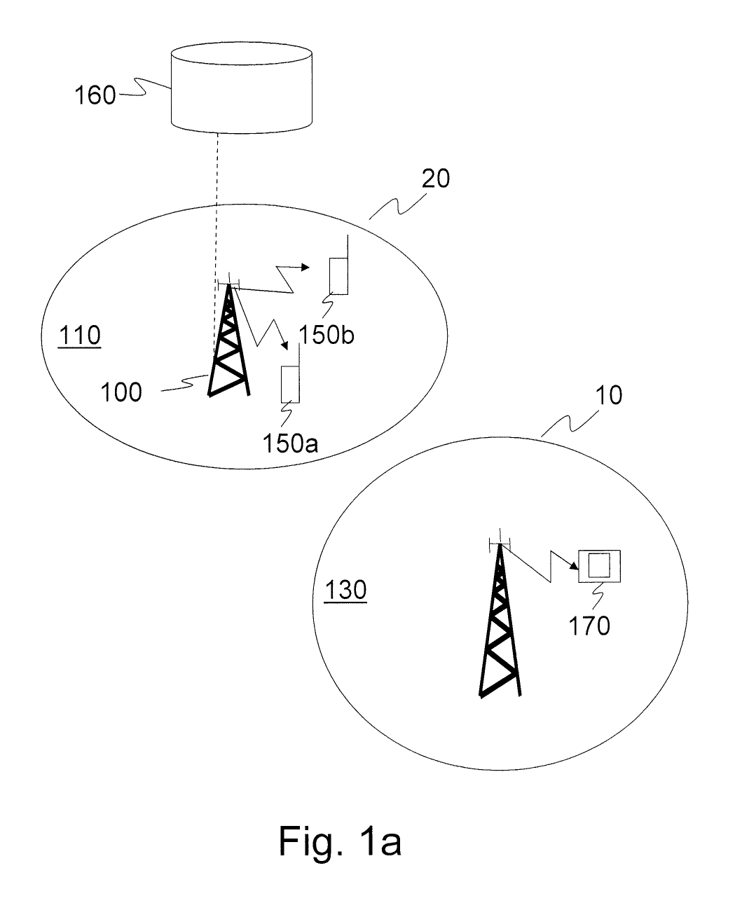

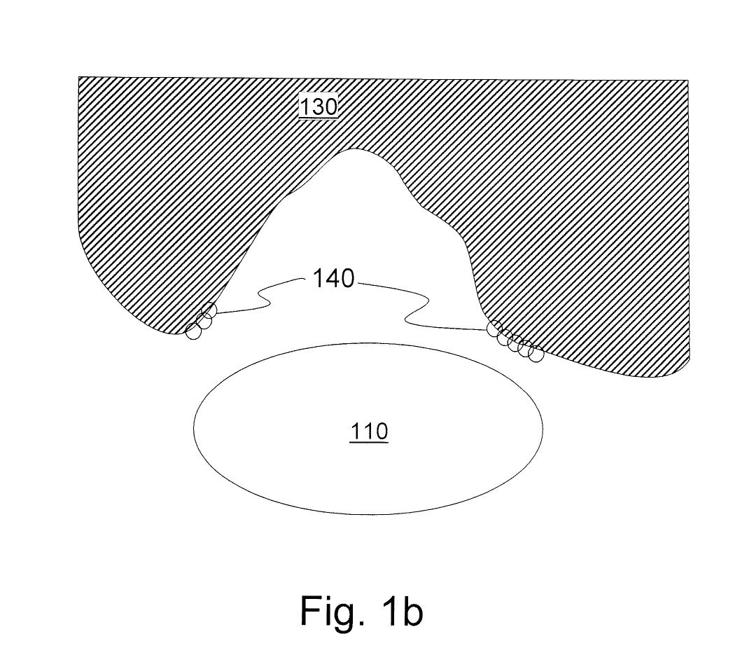

Embodiments will hereinafter be described with reference to the non-limiting example scenario illustrated in FIG. 1a, where the secondary system 20 is an e-UTRAN, the eNB 100 is the master network node with a service coverage area 110, and the UEs 150a-b are the slave WSDs within the service coverage area 110 controlled or served by the network node. The eNB 100 is thus the network node that controls the UL power allocation of the UEs. The primary system 10 is in this example scenario a TV broadcast system providing a TV broadcast service to the primary TV receivers 170 in a certain service area 130. In this example scenario, optimization of UL power allocation to the WSDs is addressed.

However, in an alternative exemplary embodiment the secondary system may be any other type of wireless communication system supporting white space usage. The master network node may for example be a Radio Network Controller (RNC) in an UTRAN, and the WSDs may be the RBSs or NodeBs controlled by the RNC. In other embodiments the master network node may be a Wireless Local Area Network (WLAN) access point and the WSDs may be served WLAN clients. The master network node may also be a Core Network (CN) node in the e-UTRAN, and the WSDs may then be the white space device enabled eNBs within the CN node service area. In this latter example, optimization of downlink power allocation to the WSDs is addressed instead. Similarly, also the primary system may be any other type of system, including radar systems and aeronautical navigation systems.

The iterative method for determining the margin of the interference threshold level received from the geo-location database comprises the following steps performed in the eNB according to one embodiment.
1. The eNB queries the geo-location database for information on the channels available for secondary usage, the corresponding critical positions, and the corresponding interference threshold levels. In one embodiment, the eNB service area is given in the query, and the geo-location database replies with the channels available for secondary usage in this service area, and the corresponding critical positions and interference levels. In another embodiment, the eNB may receive the service area of the primary system instead of the critical positions and the corresponding interference levels, and may then compute the critical positions and the interference levels itself. These steps are already known from prior art.
2. The eNB estimates the channel gains between the eNB and all WSD/UEs that it controls. This may be done based on the use of pilots in nearby previously set up white space channels and an extrapolation, or based on a calculation using appropriate channel models.
3. The eNB calculates or estimates channel gains between the UEs and critical positions, e.g. by use of appropriate channel models, pre-defined propagation models and antenna diagrams. The estimation of the channel gains may be improved if, e.g., there is some feedback mechanism from the primary receivers implemented or if there is measurement equipment deployed by e.g. the secondary system operator for measuring the aggregated interference at representative critical positions.
4. The eNB initializes the margin of the interference level, i.e., sets an initial margin value to account for the aggregated interference. This means that the aggregated interference from UEs transmitting on the white space channel must be below what a primary receiver in the critical position can tolerate with the margin added.
5. The eNB determines UE transmit power allocations, maximizing the sum rate or some other suitable criterion of the UE transmissions by solving a standard convex optimization problem with constraints on the maximally allowed aggregated interference level with the margin added. There are several alternative conventional methods for solving such a convex optimization problem with constraints.
6. The eNB evaluates whether the determined UE transmit power allocation, i.e., the power allocation in UL, generates a probability distribution of the aggregated interference that yield a sufficiently low, but not too low, probability of exceeding the interference threshold level at all critical positions. A probability interval, comprising the probabilities of causing interference to the primary system that are acceptable, is used for the evaluation. A too high interference probability is undesired for obvious reasons and a probability threshold is likely to be defined and controlled by regulatory rules. Such a probability threshold may form the upper endpoint of the probability interval in one embodiment. However, a lower endpoint of an interval is also desired, as a too low interference probability means that the power levels can be increased while still keeping the probability of causing harmful interference low enough. All probabilities falling below the lower endpoint of the probability interval is thus undesirable from a secondary system capacity point of view.
7. Therefore, if the probability of causing an aggregated interference that exceeds the interference threshold level is too high and thus falls outside of the probability interval, i.e., exceeds an upper endpoint of the probability interval in this embodiment, the margin is increased. If the probability is too low and thus also falls outside of the probability interval, in this case below a lower endpoint of the probability interval, the margin is decreased. The method then iterates from step 5 above. If the probability falls within the probability interval, the obtained UE power allocation is the optimal allocation that protects the primary receivers at the specified level. In that case no more iteration is needed and the method continues with step 8 below. It should be noted that a probability of not exceeding the interference threshold level at the critical positions may be used instead of the probability of exceeding the interference threshold level in an alternative embodiment, which of course affects the allowed probability interval used in steps 6 and 7.
8. The master network node allocates transmit power to the WSDs according to the determined UL transmit powers in step 5.

Steps 1 and 2 could be performed simultaneously or in the opposite order.

A critical position is, as already explained above, a position within a primary system coverage area such as a TV broadcast coverage area where the aggregated interference generated by the transmissions from the secondary system (in our example the eNB and the UEs) is expected to be the largest. The critical positions may be the set of positions in the TV broadcast coverage area that are closest to the eNB service area, as illustrated in FIG. 1b. In the query to the geo-location database, the master network node specifies its service area and in the reply the geo-location database specifies, for each allowed channel, the corresponding set of critical positions. Along with each critical position the maximally allowed aggregated interference level is specified in the reply. The probability that the total aggregated interference caused by secondary systems exceeds this interference level must fall within a probability interval, and thus must not be too high or too low. The probability interval, or at least one endpoint of the interval, may be pre-determined, i.e. configured according to regulatory requirements, or given in the geo-location database reply.

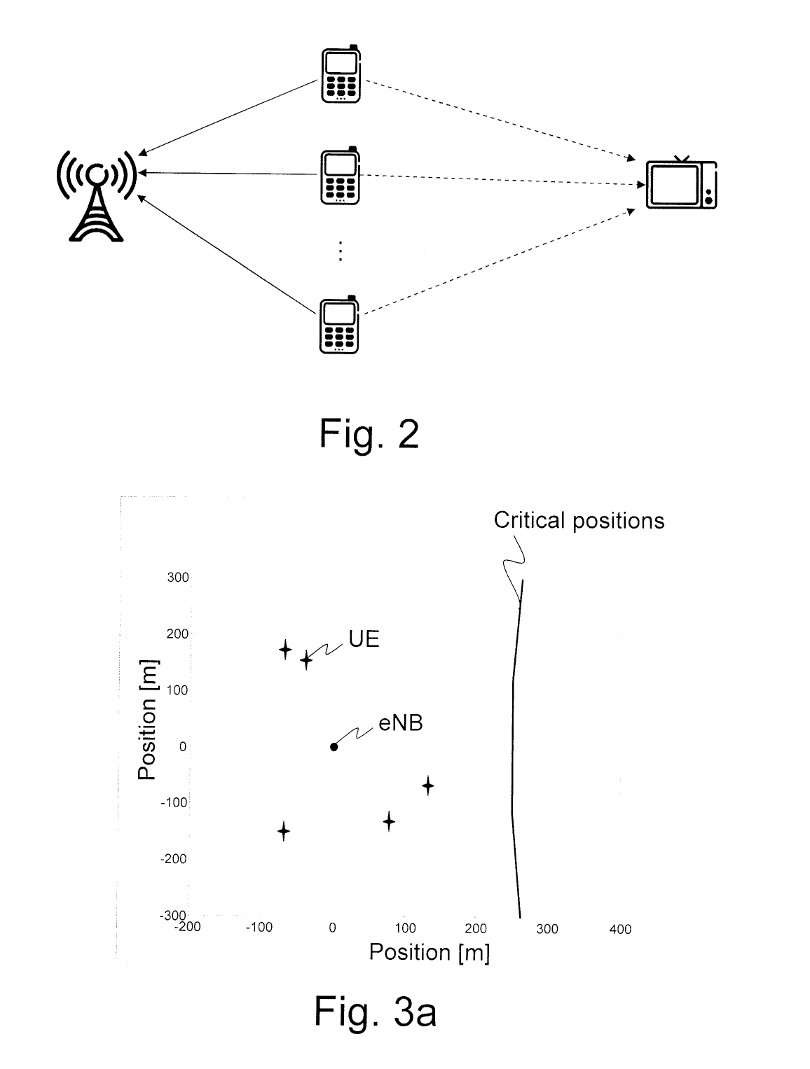

FIG. 2 illustrates schematically the useful secondary UL communication links with continuous arrow lines and the generated interference towards a primary receiver at a critical location with dashed arrow lines.

The optimization problem in step 5 is the sum rate maximization of UL transmission. In other embodiments other optimization criteria may be considered. In efficient communication schemes UL transmission schemes may be considered as orthogonal, i.e., the interference between the different UL transmissions may be neglected or assumed to be constant. This implies that the optimization problem we want to solve, i.e., rate maximization, may be stated according to the following. Maximize

$${\sum }_{n = 1}^{N} {log}_{2} ( 1 + \frac{{G}_{nn} {p}_{n}}{{W}_{n} + I} ) \qquad ( 1 )$$

subject to

$$Pr ( {\sum }_{n = 1}^{N} {G}_{x , n} {p}_{n} > {I}_{th} ) < ɛ \\ 0 < {p}_{n} < {p}_{max ,} , ∀ n \qquad ( 2 )$$

where the probability constraint (2) must hold for all critical positions xᵢ, and where N is the number of UEs, pₙ is the transmit power of UE n, Gₓₙ is the channel gain between the UE n and the primary receiver at the critical position xᵢ, and Gₘ, is the channel gain between the UE n and the eNB. Iₜₕ is the interference threshold level obtained from the geo-location database, below which the aggregated interference caused by the secondary transmissions towards the primary receiver must be kept with a probability of (1−ε). Further, Wₙ is the noise and I is interference due to the TV broadcast transmissions at the eNB. pₘₐₓ is the maximal output power of the UEs, dictated by hardware limitations or regulatory specifications, or by secondary system preferences that may depend on the secondary communication link quality.

It should be noted that the optimization procedure also straightforwardly generalizes to situations where different margins and/or interference levels for each critical position are specified as well as to situations where different UEs have different maximal possible transmit powers.

This problem is possible to reformulate as a convex optimization problem according to the following. Maximize

$${\sum }_{n = 1}^{N} {log}_{2} ( 1 + \frac{{G}_{nn} {p}_{n}}{{W}_{n} + I} ) \qquad ( 3 )$$

subject to

$${\sum }_{n = 1}^{N} {G}_{x , n} {p}_{n} < {I}_{th} - {I}_{margin} \\ 0 < {P}_{n} < {p}_{max} , ∀ n \qquad ( 4 )$$

where the constraint (4) must hold for all critical positions xᵢ, and where the margin I_{margin} has been introduced. The optimal setting of I_{margin}, that make the solution to (3) and (4) equivalent with the solution to (1) and (2) respectively, will depend on the threshold s as well as the number of UEs N and the associated propagation models. The problem in (3) and (4) is easy to solve using standard methods for solving convex optimization problems. The cvx toolbox for Matlab may for example be used.

The original problem in (1) and (2) is solved by using an iterative method to find the I_{margin} so that

$${P}_{HI , x} ≡ Pr ( {\sum }_{n = 1}^{N} {G}_{x , n} {p}_{n} > {I}_{th} - {I}_{margin} ) < ɛ \qquad ( 5 )$$

is fulfilled for all critical positions xᵢ. To maximize the UL capacity the probability should not be too low either so the I_{margin} is actually iteratively updated until the maximal aggregated interference position satisfies (according to step 6 above):

$${P}_{HI}^{max} ≡ {max}_{x ,} Pr ( {\sum }_{n = 1}^{N} {G}_{x , n} {P}_{n} > {I}_{th} - {I}_{margin} ) ∈ [ ɛ - {ɛ}^{′} , ɛ ] \qquad ( 6 )$$

The eNB thus evaluates whether the UL power allocation derived from the convex optimization problem results in a probability distribution of the aggregated interference that yields a sufficiently low, but not too low, probability of exceeding the interference threshold level at the critical point experiencing the highest aggregated interference level, i.e.:

P_{Hi,x}_{ᵢ}<ε,∀xᵢ, P_{HI}^{max}ε[ε−ε′,ε] (7)

The ε′ is a parameter that is typically much lower than ε. In the example realization described hereinafter, the acceptable probability interval is chosen to be [0.95%, 1%]. The condition in (6) may in one embodiment be evaluated using the well known Fenton Wilkinson method, for approximation of the sum of the log-normal distributions of each interfering signal. In another embodiment the probability may be estimated using standard Monte-Carlo methods. In these situations the expression (6) will look different and the channel model uncertainty captured by I_{margin} may instead be more explicitly captured by, e.g., a stochastic fading parameter.

The way the margin I_{margin} is updated in one embodiment is by choosing an initial value of zero dB, i.e I_{margin}⁽⁰⁾=0 dB, (initialization according to step 4 above) and choosing a maximal margin value I_{margin}^{max} that is very large, e.g. 120 dB. In each iteration:
if the probability P_{HI}^{max} is larger than ε, the minimal margin value is set to I_{margin}^{min}=I_{margin}⁽ⁿ⁾ and then the margin is increased to I_{margin}⁽ⁿ⁺¹⁾=I_{margin}⁽ⁿ⁾+½(I_{margin}^{max}−I_{margin}^{min});
if the probability P_{HI}^{max} is lower than the ε−ε′, the maximal margin value is set to I_{margin}^{max}=I_{margin}⁽ⁿ⁾ and then the margin is decreased to I_{margin}⁽ⁿ⁺¹⁾=I_{margin}⁽ⁿ⁾−½(I_{margin}^{max}−I_{margin}^{min})

The new value I_{margin}⁽ⁿ⁺¹⁾ is then used as I_{margin} the convex optimization problem margin (3) and (4) to find the power allocation and subsequently to evaluate the validity of the power allocation by using the constraint (6), as described above.

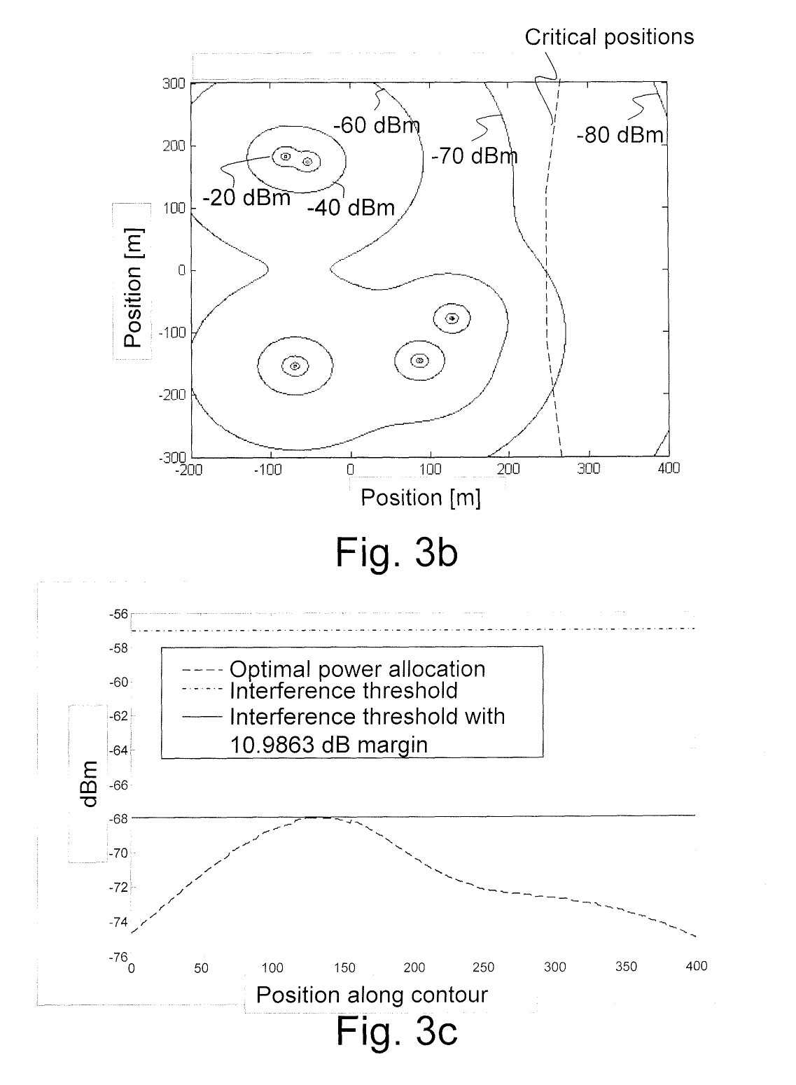

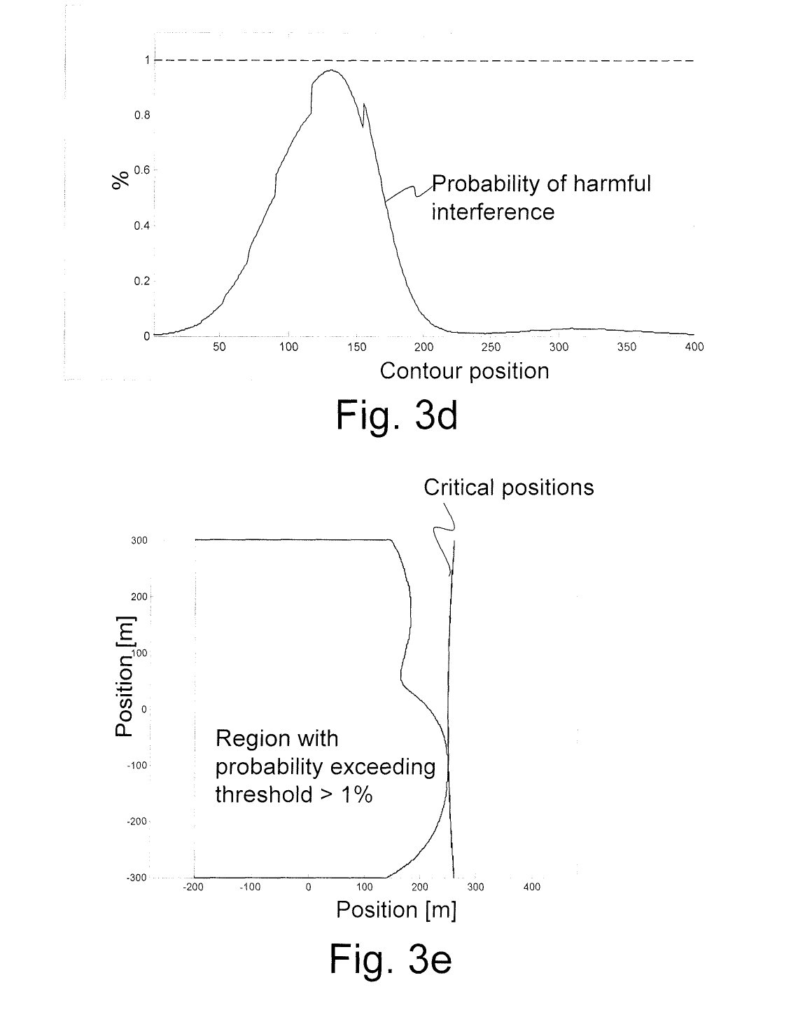

A simulation of an example realization of the optimization algorithm has been performed to verify the method, and will be described in the following to give evidence that the above outlined method for allocating powers performs as indicated. In the example scenario, five UEs, i.e., N=5, as illustrated in FIG. 3a, are allocated UL transmit powers. The critical positions are assumed to be on the part of the TV coverage contour that is visible in the figure.

In the simulations an interference threshold level of Iₜₕ=−57 dBm and an acceptable interval for the probability of harmful interference [ε−ε′, ε]=[0.95%,1%] is assumed. The optimization procedure converges in this realization rather quickly to a margin of 11 dB. The optimal power allocation with a maximum UE transmit power of pₘₐₓ=20 dBm, is found to be the following for each UE:

p₁=6.7641 dBm
p₂=12.7213 dBm
p₃=20.0000 dBm
p₄=20.0000 dBm
p₅=20.0000 dBm

This UL power allocation generates the mean aggregated interference shown in FIG. 3b. Further, the mean aggregated interference along the contour is shown in FIG. 3c. In this figure, left to right corresponds to down to up in FIG. 3b. With this figure it is verified that the solution of the convex optimization problem in (3) and (4) with the correct margin indeed respects the constraints.

FIG. 3d illustrates the probability of exceeding the interference threshold level at the critical positions along the contour. Indeed the maximum probability of interference at any critical location is 0.96%, i.e., within the acceptable probability interval [0.95%,1%] defined as the interval comprising the probabilities of causing interference to the primary system that are acceptable.

FIG. 3e illustrates the region in which the probability of exceeding the interference threshold level is above 1%. The coverage contour, i.e, the set of critical positions, is almost tangential to this region at the critical position having the maximal probability of harmful interference. This is to be expected from a well behaving power allocation process since this indicates that the UEs UL transmit power are set so that the maximal capacity or the sum rate is achieved without violating the primary protection requirements.

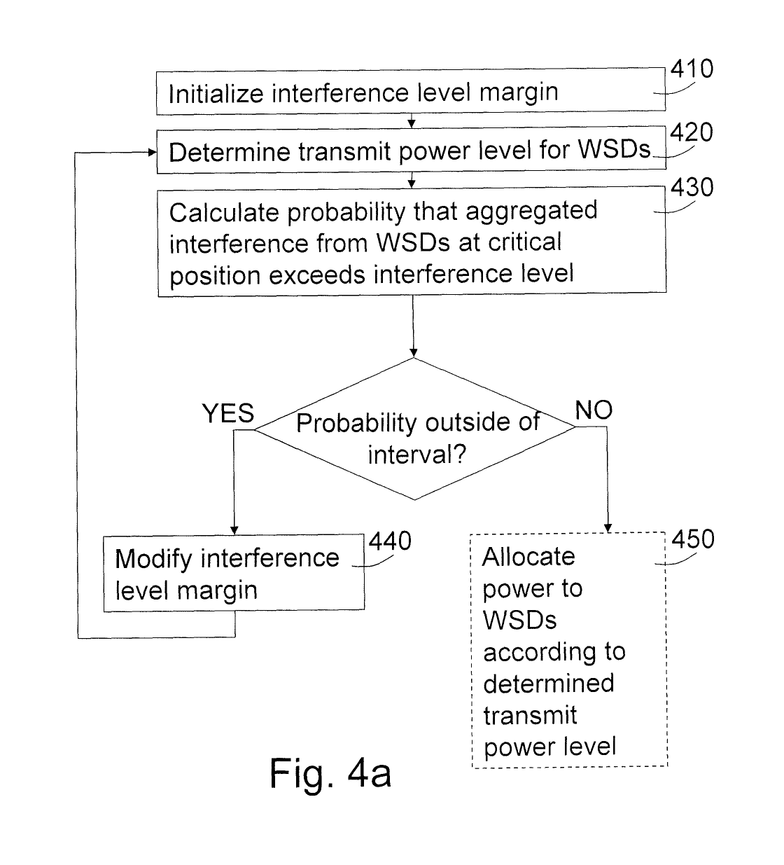

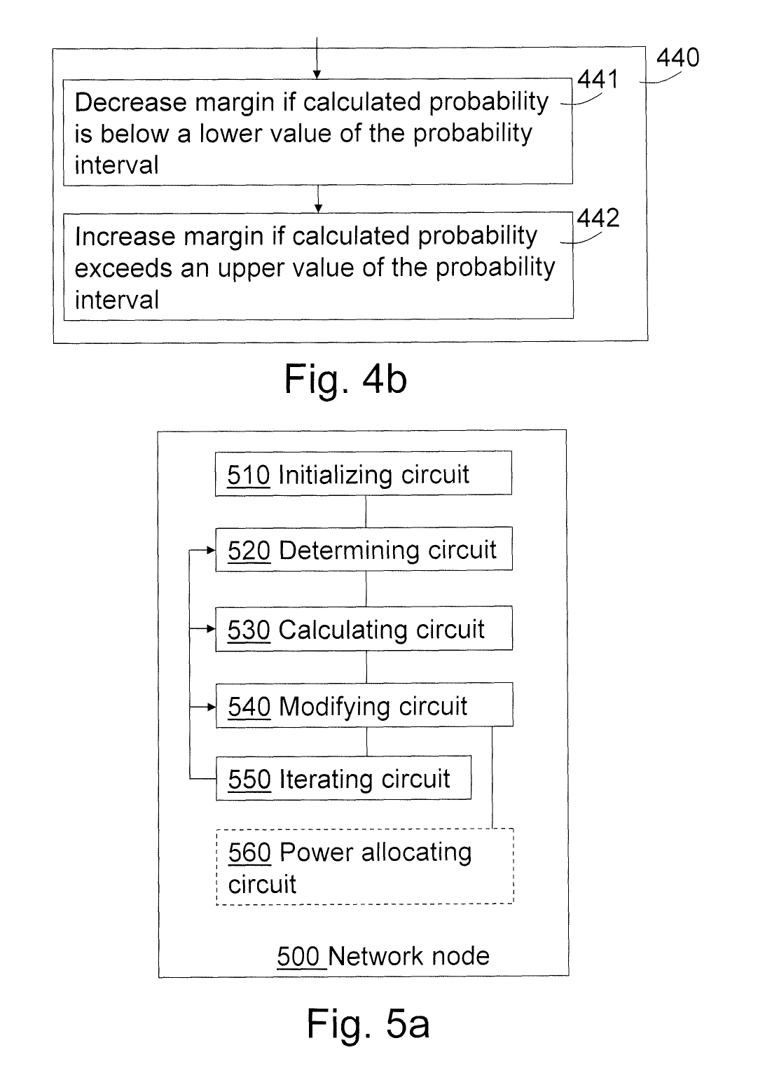

FIG. 4a is a flowchart of the method in the network node of a wireless network for determining a margin of an interference level, according to embodiments. The network node is in one embodiment an RBS such as an eNB in LTE acting as the master WSD. In another embodiment, the network node is a node, such as a CN node, controlling whites space RBSs, such as eNBs in LTE acting as WSDs. The network node controls at least one WSD, and the interference level is associated with a critical position and a channel available for secondary usage by the WSDs. The interference level, the critical position, and the channel available for secondary usage may be received from the geo-location database, as described above. The method comprises:
410: Initializing the margin (step 4 in the embodiment described above). The margin may for example be set to zero dB.
420: Step a)—Determining transmit power levels for the WSDs when transmitting on the channel available for secondary usage. This is done based on the interference level with the margin added. The optimization problem in (3) and (4) may be used in one embodiment.
430: Step b)—Calculating a probability that an aggregated interference from the WSDs at the critical position exceeds the interference level, based on the determined transmit power levels and a channel model uncertainty (step 6 above).
440: Step c)—Modifying the margin of the interference level if the calculated probability falls outside of a probability interval. As illustrated in FIG. 4b, modifying comprises decreasing 441 the margin of the interference level if the calculated probability is below a lower endpoint of the probability interval, and increasing 442 the margin of the interference level if the calculated probability exceeds an upper endpoint of the probability interval. At least one of the lower or upper endpoints of the probability interval may be pre-determined, i.e. set according to regulatory requirements, or may be received from the geo-location database.

The steps b) 420, c) 430, and d) 440 may be iterated until the calculated probability falls within the probability interval if needed.

The method may in embodiments also comprise the step of allocating 450 transmit power to the WSDs according to the determined transmit power levels.

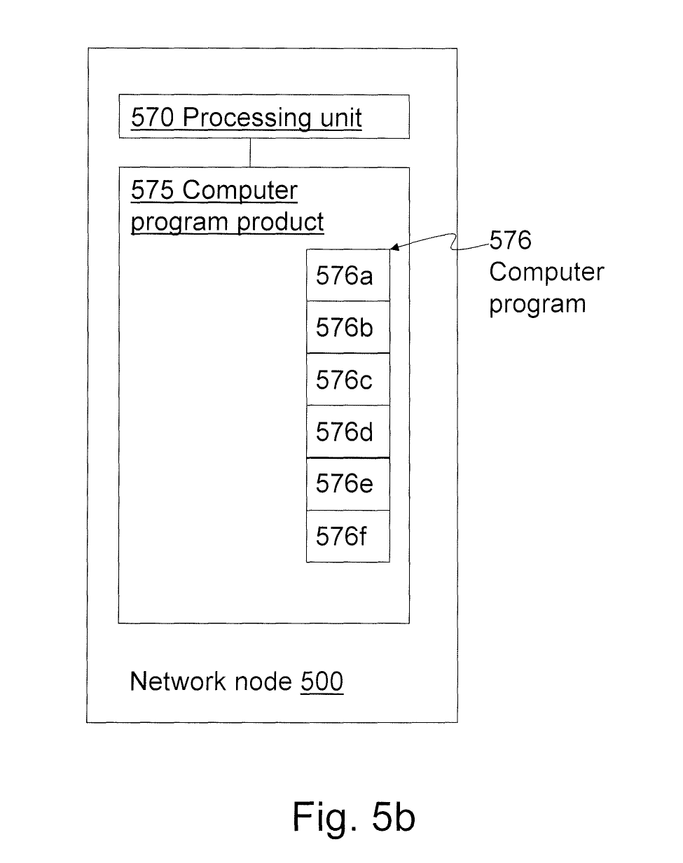

A network node 500 is schematically illustrated in FIG. 5a according to embodiments. The network node 500 is in one embodiment an RBS such as an eNB in LTE acting as the master WSD. In another embodiment, the network node is a node, such as a CN node, controlling whites space RBSs, such as eNBs in LTE acting as WSDs. The network node 500 is configured to determine a margin of an interference level and to control at least one WSD. The interference level is associated with a critical position and a channel available for secondary usage by the WSDs. The interference level, the critical position, and the channel available for secondary usage may be received from the geo-location database, as described above. The network node 500 comprises an initializing circuit 510 configured to initialize the margin. It may for example be set to zero dB. It also comprises a determining circuit 520 configured to determine a transmit power level for the WSDs when transmitting on the channel available for secondary usage, which is done based on the interference level with the margin added. The network node 500 further comprises a calculating circuit 530 configured to calculate a probability that an aggregated interference from the WSDs at the critical position exceeds the interference level, based on the determined transmit power levels and a channel model uncertainty, and a modifying circuit 540 configured to modify the margin of the interference level, if the calculated probability falls outside of a probability interval. In embodiments of the invention, the modifying circuit 540 is further configured to decrease the margin of the interference level if the calculated probability is below a lower endpoint of the probability interval, and to increase the margin of the interference level if the calculated probability exceeds an upper endpoint of the probability interval. At least one of the lower or upper endpoints of the probability interval may be pre-determined, i.e. set according to regulatory requirements, or may be received from the geo-location database.

The network node also comprises an iterating circuit 550 configured to control the determining circuit 520, the calculating circuit 530, and the modifying circuit 540 to iterate the transmit power level determination, the probability calculation and the margin modification, until the calculated probability falls within the probability interval. In embodiments, the network node 500 may also comprise a power allocating circuit 560 configured to allocate transmit power to the WSDs according to the determined transmit power levels.

The network node 500 may comprise a conventional communication circuit designed to communicate with the WSDs via transmit and receive antennas. The communication circuit is used to inform the WSDs about the transmit power allocation and to communicate useful data to and from the WSDs.

The circuits described above with reference to FIG. 5a are logical circuits and do not necessarily correspond to separate physical circuits.

FIG. 5b schematically illustrates an embodiment of the network node 500, which is an alternative way of disclosing the embodiment illustrated in FIG. 5a. The network node 500 comprises a processing unit 570 which may be a single unit or a plurality of units. Furthermore, the network node 500 comprises at least one computer program product 575 in the form of a non-volatile memory, e.g. an EEPROM (Electrically Erasable Programmable Read-Only Memory), a flash memory or a disk drive. The computer program product 575 comprises a computer program 576, which comprises code means which when run on the network node 500 causes the processing unit 570 on the network node 500 to perform the steps of the procedures described earlier in conjunction with FIG. 4a.

Hence in the embodiments described, the code means in the computer program 576 of the network node 500 comprises an initializing module 576a for initializing the margin, and a determining module 576b for determining the transmit power level for the WSD. It also comprises a calculating module 576c for calculating the probability of exceeding the interference level, a modifying module 576d for modifying the interference level margin, and an iterating module 576e for iterating the transmit power level determination, the probability calculation and the margin modification, until the calculated probability falls within the probability interval. In embodiments, the code means may also comprise a power allocating module 576f for allocating the determined transmit power level to the at least one white space device. The code means may thus be implemented as computer program code structured in computer program modules. The modules 576a-f essentially perform the steps of the flow in FIG. 4a to emulate the network node described in FIG. 5a. In other words, when the different modules 576a-f are run on the processing unit 570, they correspond to the units 510-560 of FIG. 5a.

Although the code means in the embodiment disclosed above in conjunction with FIG. 5b are implemented as computer program modules which when run on the network node 500 causes the node to perform steps described above in the conjunction with FIG. 4a, one or more of the code means may in alternative embodiments be implemented at least partly as hardware circuits.

The above mentioned and described embodiments are only given as examples and should not be limiting. Other solutions, uses, objectives, and functions within the scope of the accompanying patent claims may be possible.

### ABBREVIATIONS

### BS Base Station

### CEPT European Conference of Postal and Telecommunications

### CN Core Network

eNB evolved Node B
e-UTRAN evolved Universal Terrestrial Radio Access Network

### FCC Federal Communications Commission

### LTE Long Term Evolution

### RBS Radio BS

### UE User Equipment

### UL Uplink

### UMTS Universal Mobile Telecommunications System

### WLAN Wireless Local Area Network

WSD White Space Device

1-16. (canceled)

17. A method in a network node of a wireless network for determining a margin of an interference level, wherein the network node controls at least one white space device, and the interference level is associated with a critical position and a channel available for secondary usage by the at least one white space device, the method comprising:
initializing the margin;
determining a transmit power level for the at least one white space device when transmitting on the channel available for secondary usage, based on the interference level with the margin added;
calculating a probability that an aggregated interference from the at least one white space device at the critical position exceeds the interference level, based on the determined transmit power level and a channel model uncertainty;
modifying the margin of the interference level if the calculated probability falls outside of a probability interval; and
iterating said determining, calculating, and modifying until the calculated probability falls within the probability interval.

18. The method of claim 17, wherein modifying the margin of the interference level comprises:
decreasing the margin of the interference level if the calculated probability is below a lower endpoint of the probability interval; and
increasing the margin of the interference level if the calculated probability exceeds an upper endpoint of the probability interval.

19. The method of claim 17, further comprising allocating transmit power to the at least one white space device according to the determined transmit power level.

20. The method of claim 17, wherein at least one endpoint of the probability interval is pre-determined.

21. The method of claim 17, wherein at least one endpoint of the probability interval is received from a geo-location database.

22. The method of claim 17, wherein at least one of the interference level, the critical position, and the channel available for secondary usage is received from a geo-location database.

23. The method of claim 17, wherein the network node is a radio base station.

24. The method of claim 17, wherein the network node controls at least one white space radio base station.

25. A network node for a wireless network, configured to determine a margin of an interference level and to control at least one white space device, wherein the interference level is associated with a critical position and a channel available for secondary usage by the at least one white space device, the network node comprising:
an initializing circuit configured to initialize the margin;
a determining circuit configured to determine a transmit power level for the at least one white space device when transmitting on the channel available for secondary usage, based on the interference level with the margin added;
a calculating circuit configured to calculate a probability that an aggregated interference from the at least one white space device at the critical position exceeds the interference level, based on the determined transmit power level and a channel model uncertainty;
a modifying circuit configured to modify the margin of the interference level, if the calculated probability falls outside of a probability interval; and
an iterating circuit configured to control the determining circuit, calculating circuit, and modifying circuit to iterate the transmit power level determination, the probability calculation and the margin modification, until the calculated probability falls within the probability interval.

26. The network node of claim 25, wherein the modifying circuit is further configured to decrease the margin of the interference level if the calculated probability is below a lower endpoint of the probability interval and to increase the margin of the interference level if the calculated probability exceeds an upper endpoint of the probability interval.

27. The network node of claim 25, further comprising a power allocating circuit configured to allocate transmit power to the at least one white space device according to the determined transmit power level.

28. The network node of claim 25, wherein at least one endpoint of the probability interval is pre-determined.

29. The network node of claim 25, wherein at least one endpoint of the probability interval is received from a geo-location database.

30. The network node of claim 25, wherein at least one of the interference level, the critical position, and the channel available for secondary usage is received from a geo-location database.

31. The network node of claim 25, wherein the network node is a radio base station.

32. The network node of claim 25, wherein the network node is configured to control at least one white space radio base station.
